(19) United States
(12) Patent Application Publication
(10) Pub. No.: US 2010/0159423 A1
(43) Pub. Date: Jun. 24, 2010

(54) Tactile Pin Display Apparatus

(76) Inventors: Michinori Hashizume, Kyoto (JP); Jiro Kajino, Osaka (JP); Kaoru Shimizu, Osaka (JP); Tomohiro Asao, Osaka (JP)

Correspondence Address: ISABELLE R. MCANDREWS, P.O. BOX 3074, FREMONT, CA, 94539, US

(21) Appl. No.: 11/991,900

(22) PCT Filed: Jul. 30, 2007
(86) PCT No.: PCT/JP2007/064883

§ 371 Date: Mar. 12, 2008

(51) Int. Cl. G09B 21/00

(52) U.S. Cl. 434/114

(57) ABSTRACT

A tactile pin display apparatus comprises: tactile pins 20 for braille display; a support housing 30 for supporting and allowing the tactile pins 20 to move forward and backward; cams 40 for raising ends of the tactile pins 20 to a desired height (ON-state) from a tactile surface 35; compression coil springs 10 for biasing the tactile pins 20 against the cams 40; shape memory wires 60 to be heated by current for pivoting the cams 40 forward to bring the tactile pins to the ON-state; and a cam return plate 50 for pivoting the cams backward to lower the tactile pins 20 back to a level (OFF-state) of the tactile surface 35. Even if in the ON-state the tactile pins 20 are strongly pressed by a user, or the current to the shape memory wires 60 is disconnected, the tactile pins 20 are not lowered back because upper surfaces of the cams 40 support lower surfaces of the tactile pins 20. All the tactile pins 20 can be lowered back to the OFF-state by a single reciprocal movement of the cam return plate 50.

### TECHNICAL FIELD

The present invention relates to a tactile pin display apparatus for displaying braille numbers formed of substantially semi-spherical projections (or tactile pins) of multiple dots (e.g. four dots), or arbitrary braille characters formed of substantially semi-spherical projections (or tactile pins) of multiple dots (e.g. six or eight dots), or arbitrary braille graphics. More specifically, it relates to a tactile pin display apparatus which uses cams and shape memory wires to raise ends of tactile pins to a desired height (“ON” state) from a tactile surface.

### BACKGROUND ART

A conventional tactile pin (braille) display apparatus arranges, into one line of character string for display, a predetermined number of braille display members (braille display units) which electromechanically raise ends of multiple tactile pins (braille pins) for braille display. A visually handicapped person slides a finger on the line for tactile (reading) so as to transfer information to the visually handicapped person. Japanese Laid-open Patent Publication 2005-070716 proposes a tactile pin display apparatus: having a structure in which the expansion and contraction of a shape memory wire (alloy) is converted into rotation of a cam, and a tactile pin is pushed out by this cam, so as to place the shape memory wire in a direction substantially perpendicular to the tactile pin; and also having a structure in which by the shape of the cam, or by combining a spring with the cam which thereby performs a toggle motion, the ON-state of the tactile pin (state in which the end of the tactile pin is at a high level position raised from the tactile surface) is maintained without flowing a holding current.

However, in the tactile pin display apparatus proposed by Japanese Laid-open Patent Publication 2005-070716, the placement distance between the tactile pins for braille display is close such as about 2.5 mm to 3 mm, so that the placement pitch is small. As a result, as shown in FIGS. 3 and 4 of the same Patent Publication, if a spring 13 is used in combination, the axial center in the lengthwise direction of a tactile pin and the rotation-axial center of a cam could not be close to each other. Specifically, the rotation-axial center of the cam was required to be significantly far from the axial center in the lengthwise direction of the tactile pin to prevent cams to push out the tactile pins from interfering with each other. However, the shape memory wire is non-conducting in the ON-state of the tactile pin, so that if the rotation-axial center of the cam is significantly far from the axial center in the lengthwise direction of the tactile pin, the cam cannot fix and support the tactile pin, because a rotational moment is exerted on the cam, resulting in a rotation of the cam, when the tactile pin is pressed by a finger with a force of 0.1 N to 0.3 N for tactile, even if the tactile pin in the ON-state rides on the cam surface. In order to solve this, the spring 13 was required to be combined with the cam to allow the cam to perform a toggle motion.

Furthermore, the tactile pin does not automatically return to the OFF-state (state where the end of the tactile pin is positioned at substantially the same level as the tactile surface), not returning to the OFF-state unless the tactile pin is pressed by a finger. Conversely, the force to support the tactile pin is set to be a supporting force such that the tactile pin returns to the OFF-state when pressed with a strong finger force. However, the setting of such supporting force means that it is difficult to stably maintain the tactile pin in the OFF-state. Furthermore, if the tactile pin is continuously biased e.g. by a compression coil spring against the cam for the purpose of enabling the tactile pin to automatically return to the OFF-state, a rotational moment is exerted on the cam. Accordingly, there is a risk that in the ON-state, the cam which should be stationary may be forced to rotate. Thus, it was not possible to allow the tactile pin to automatically return to the OFF-state by using e.g. a compression coil spring.

Accordingly, a process is necessary to touch newly displayed tactile pins (braille) after once using a finger to press and reset all the tactile pins in the ON-state to the OFF-state, resulting in an extremely complicated tactile operation. This is also a big obstacle when continuously displaying the tactile pins (braille). Further, as shown in the drawings of the same Patent Publication, the shape memory wire is fixed to an outer periphery of a pulley, and is grounded through a shaft which supports the pulley. Thus, there is a risk that this may cause an unstable contact resistance. Note that also in FIG. 1 and FIG. 2 of the same Patent Publication showing a tactile pin display apparatus which does not use a spring, it is presumed difficult to place the tactile pins at narrow intervals of 2.5 mm to 3 mm, making it difficult to form a tactile pin display apparatus for braille display of multiple rows and multiple columns.

### DISCLOSURE OF INVENTION

An object of the present invention is to provide a tactile pin display apparatus: which holds a tactile pin in an ON-state without requiring the application of a current to a shape memory wire or the introduction of a toggle mechanism e.g. using a spring, even if the rotation-axial center of a cam is a little far (offset) from the axial center in the lengthwise direction of the tactile pin (braille pin); and which can prevent the cam from rotating to allow the tactile pin to move from the ON-state to the OFF-state, even if the tactile pin is pressed with a strong finger force; and which at the same time can allow the tactile pin in the ON-state to return to the OFF-state.

According to the present invention, this object is achieved by a tactile pin display apparatus comprising: tactile pins for displaying characters and/or graphics; a support housing for supporting and allowing the tactile pins to move forward and backward; cams for raising ends of the tactile pins to a desired height from a tactile surface; springs for biasing the tactile pins against the cams; shape memory wires to be heated by current for pivoting the cams forward in a direction to raise the ends of the tactile pins to the desired height from the tactile surface; and cam return means including a cam return member to engage with the cams, and a cam return member driving source for reciprocating the cam return member so as to pivot the cams backward in a direction to move the ends of the tactile pins to a level substantially corresponding to the tactile surface when the cam return member driving source moves the cam return member forward.

This structure in the tactile pin display apparatus of the present invention allows the cams in the ON-state to support the tactile pins, and prevents ends of the tactile pins from being lowered back to the OFF-state from the ON-state even if the tactile pins are pressed by a finger of a user with a large force of about 1 N (newton) to 10 N. This eliminates the need for a holding current to maintain the tactile pins, making it possible to achieve energy reduction. In addition, all the tactile pins can be instantaneously and automatically lowered back to near the tactile surface, namely can be instantaneously brought to the OFF-state, by a single reciprocal movement of the cam return plate and by the spring force of the springs to continuously bias the tactile pins against the cams. These make it possible to achieve the simplification and reduction of the tactile pin display apparatus in size, weight and cost.

Preferably, the shape memory wires are heated by current through conducting brushes. Further preferably, the tactile pin display apparatus further comprises wire support fittings integrally provided on the cams for pinching the shape memory wires, wherein the conducting brushes are elastically contacted with the wire support fittings so as to heat the shape memory wires by current through the wire support fittings. This makes it possible to securely link the cams to the shape memory wires, and to lower the conduction resistance to the shape memory wires, and thereby to securely and stably supply power to the shape memory wires.

Further, the cam return member driving source preferably comprises a motor, in which the cam return member is reciprocated by rotation of the motor. Otherwise, the cam return member driving source preferably comprises a solenoid, in which the cam return member is reciprocated by ON/OFF operation of the solenoid. This makes it possible to securely lower the ends of the tactile pins in the ON-state to near the tactile surface.

### BRIEF DESCRIPTION OF DRAWINGS

FIG. 1 is a schematic front view of a tactile pin display apparatus according to an embodiment of the present invention;

FIG. 2 is a schematic plan view of the tactile pin display apparatus;

FIG. 3 is a schematic side view of a main part of a tactile pin display unit showing OFF-state of tactile pins;

FIG. 4 is a schematic side view of a main part of a tactile pin display unit showing ON-state of tactile pins;

FIG. 5A is a schematic side view showing a drive mechanism using a motor for a cam return plate;

FIG. 5B is a schematic side view showing a drive mechanism using a solenoid for the cam return plate;

FIG. 6 is a schematic cross-sectional view of a main part of the tactile pin display unit of FIG. 3 cut along section line S-S;

FIG. 7 is a schematic bottom view of a main part of the tactile pin display unit of FIG. 6; and

FIG. 8 is a schematic block diagram of a control circuit as an example of a circuit to control e.g. the application of a current to a shape memory wire.

### BEST MODE FOR CARRYING OUT THE INVENTION

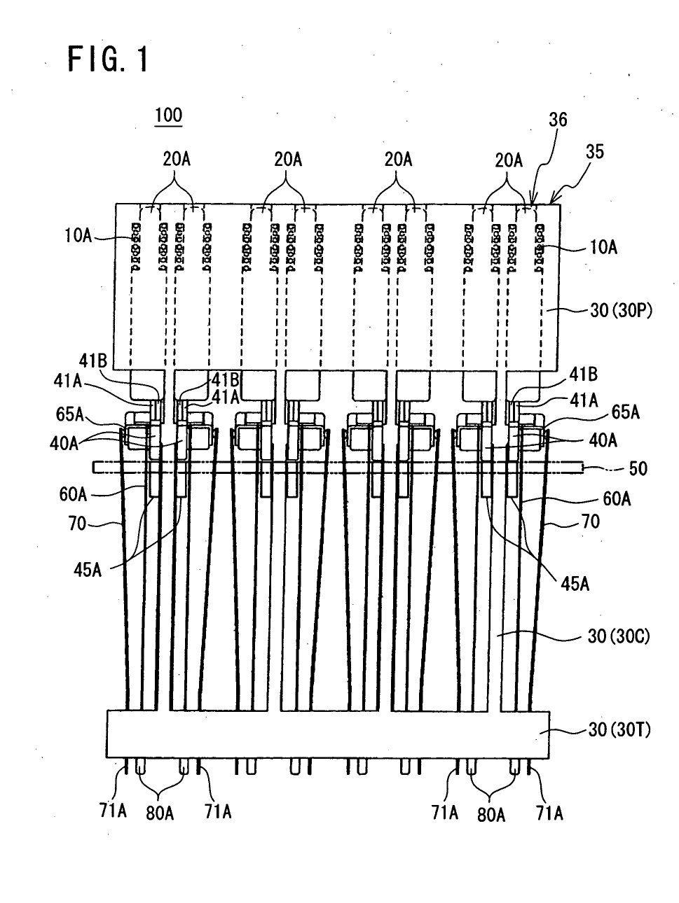

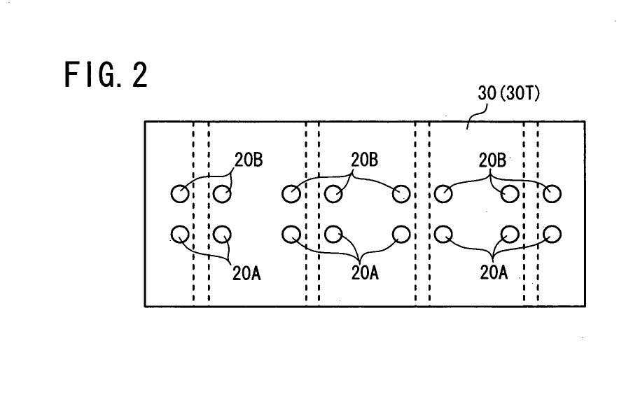

FIG. 1 is a schematic front view of a tactile pin display apparatus 100 according to an embodiment of the present invention, while FIG. 2 is a schematic plan view of the tactile pin display apparatus 100. The tactile pin display apparatus 100 can display four digit braille numbers, and is formed of eight tactile pin display units 200 described later (using two tactile pins 20A, 20B) arranged in a row at predetermined intervals. Thus, a first row of eight tactile pins 20A and a second row of eight tactile pins 20B are formed. Suffixes A and B are added to elements accompanied by the first and second tactile pins 20A and 20B, respectively, while these suffixes are not added to elements common to the first row and second row. FIG. 1 is a front view of the tactile pin units 200 arranged in a row as seen from the side of the first row.

Referring to FIG. 1 and FIG. 2, reference numeral 20A (20B) denotes stepped tactile pins made of stainless steel, and 40A (40B) denotes cams made of epoxy resin which are provided corresponding to the tactile pins 20A (20B), while 10A (10B) denotes compression coil springs made of piano wire to bias the tactile pins 20A (20B) against the cams 40A (40B). An upper surface of each cam 40A (40B) has formed thereon a cam flange 41A (41B) having flat side surfaces 41Aa, 41Ac (41Ba, 41Bc) and a curved side surface 41Ab (41Bb), as described later, to support and raise each tactile pin 20A (20B).

A cam lever member 45A (45B) is formed on a lower surface of the cam 40A (40B). Reference numeral 50 denotes a cam return plate (cam return member) with projecting members (51A, 51B described later), which when driven horizontally, contact the cam lever members 45A (45B), so as to pivot the cam lever members 45A (45B) in the driving direction. Reference numeral 30 denotes a support housing made of polystyrene resin and comprising: a tactile pin guide member 30P which has at its upper end a tactile surface 35 and openings 36 to allow the tactile pins 20A (20B) to pass through, and which supports and allows the tactile pins 20A (20B) to move forward and backward; cam support members 30C for mounting and supporting the cams 40A (40B); and a base member 30T for mounting metal sleeves 80A (80B) and external connection terminals 71 to respectively electrically connect shape memory wires 60A (60B) and conducting brushes 70, described later, to the outside, and for supporting the entire apparatus.

Reference numeral 65A denotes a wire support fitting made of nickel-plated copper material, while 60A (60B) denotes a shape memory wire with a wire diameter of e.g. 58 μm having one end which is pinched by caulking by the wire support fitting 65A, and the other end which passes through e.g. a metal sleeve embedded in the base member 30T of the support housing 30 and is pinched by the metal sleeve so as to be stretched. Reference numeral 70 denotes a conducting brush made of a phosphor bronze plate to elastically contact the rotation-axial center of the wire support fitting 65A (65B), and 80A (80B) denotes an external connection terminal made of copper and fixed by caulking to an end of the shape memory wire 60A (60B), while 71 denotes an external connection terminal which forms one end of the conducting brush 70. Note that it is obvious that when displaying braille numbers, the number of digits is not only four digits, but can be set arbitrarily.

The tactile pin display apparatus 100 of the present embodiment will be described below, including a description of the constituent elements. Generally, a braille character is displayed by six projecting dots in three rows and two columns, while a braille character (braille number) to represent numbers is formed of four projecting dots in two rows and two columns. FIG. 1 and FIG. 2 show, as an example, a tactile pin display apparatus 100 according to the present embodiment for displaying four-digit numbers. Similarly as in a general tactile pin display apparatus, the projecting dots are formed by elongated pins 20A (20B) with a diameter of about 1.0 mm to 2.0 mm. For display, the ends of the tactile pins 20A (20B) are raised by about 0.3 mm to 0.8 mm from the tactile surface 35 on the tactile pin guide member 30P of the support housing 30 through the openings 36.

The end of each tactile pin 20A (20B) is preferred to have a curved surface such as semi-spherical shape. The material of the tactile pin 20A (20B) is preferred to be selected from stainless steel and others such as nickel, aluminum having been subjected to alumite-treatment, brass, iron group metals having been subjected to anti-rust treatment, copper materials having anti-bacteria effect, resin materials and so on. Further, the surface of the end of the tactile pin 20A (20B) to be touched by a finger is preferred to have a low frictional resistance and a smooth finished surface. More specifically, the surface is preferred to have a smooth finished surface in which a difference in level between the convex and concave parts of the surface is not larger than 1.5 μm. The smooth finished surface allows a user to touch the tactile pin 20A (20B) for a long time without causing chapping or pain of the finger. If the tactile pin 20A (20B) is formed by a resin material, it is preferred to be a resin material selected from polypropylene, polystyrene, ABS, polyamide, epoxy, acryl, phenol, vinyl chloride, vinylidene chloride, and so on.

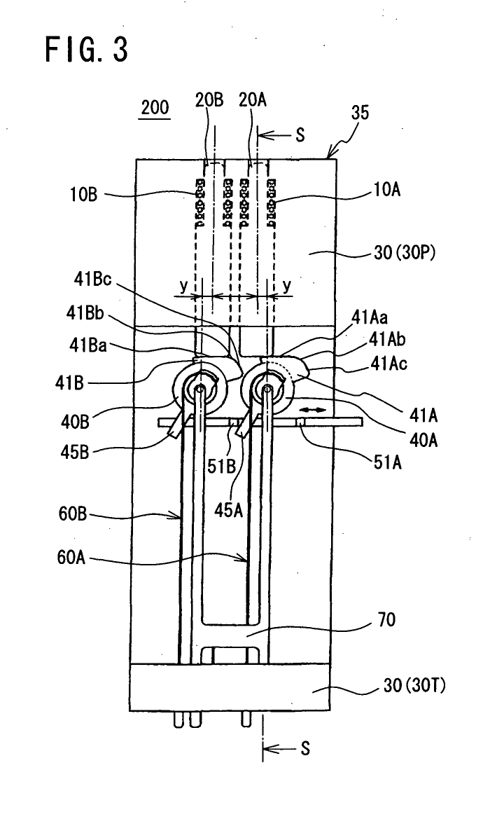

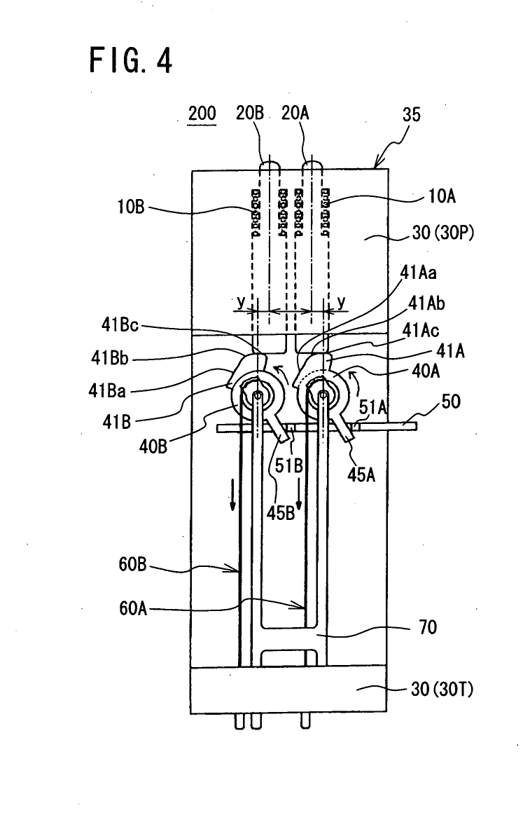

In order to raise the end of the tactile pin 20A (20B) to a desired height level from the tactile surface 35, a combination of the cam 40A (40B) and the shape memory wire 60A (60B) to pivot the cam 40A (40B) forward is used. More specifically, it is preferred that one end of the shape memory wire 60A (60B) is pinched by the wire support fitting 65A (65B) integrally provided on the cam 40A (40B), while its other end is passed through a metal sleeve embedded in the base member 30T of the support housing 30 and pinched by the metal sleeve, so as to stretch the shape memory wire 60A (60B). In order to pivot the cam 40A (40B) forward (counterclockwise: refer to FIG. 3 and FIG. 4), a current is applied to the shape memory wire 60A (60B) so as to contract the shape memory wire 60A (60B).

The current is applied to the shape memory wire 60A (60B) by applying a current between the external connection terminal 80 provided at an end of the shape memory wire 60A (60B), the conducting brush 70 elastically contacting the rotation-axial center of the wire support fitting 65A (65B), and the external connection terminal 71 connected to a lower end of the conducting brush 70. By allowing the conducting brush to elastically contact the rotation-axial center of the wire support fitting 65A (65B), it becomes possible to minimize the frictional load, and stabilize the contact resistance, between the pivoting wire support fitting 65A (65B) and the conducting brush 70. Accordingly, it is preferable that the conducting brush 70 is formed of a material having spring properties selected from a phosphor bronze plate, a spring steel plate, a brass plate, a nickel-plated steel plate, a stainless steel plate, and the like.

The wire support fitting 65A (65B) to pinch the shape memory wire 60A (60B) is preferably formed of a relatively easily deformable soft metal such as copper, brass plate, nickel-plated soft steel plate, nickel-plated aluminum plate, and the like. It is preferred to extend one end of the wire support fitting 65A (65B) to cover the rotation-axial center of the cam 40A (40B). The integration of the cam 40A (40B) and the wire support fitting 65A (65B) is preferably performed by press-fitting and fixing the wire support fitting 65A (65B) into an arc-shaped groove formed in a side surface of the cam 40A (40B). It is obvious that arbitrary means such as not only the caulking means but also adhesive means can be used as means by which the wire support fitting 65A (65B) pinches the shape memory wire 60A (60B). The cam 40A (40B) is preferably formed of a non-metallic material such as a resin material, for example, of epoxy resin, polyacetal resin, polystyrene resin, polyimide resin, or the like.

Normally, the tactile pin 20A (20B) is touched and felt by a finger of a user which presses the surface of an end of the tactile pin 20A (20B) with a pressing force of 0.1 to 0.3 N (newton). However, if, for example, the user is a beginner, and if, for some reason such as a strong pressing force exerted on the surface of the end of the tactile pin 20A (20B), an excessive pressing force is applied to the tactile pin 20A (20B), then there is a risk that the end of the tactile pin 20A (20B) could be lowered back to a non-display position at a level similar to the tactile surface 35 (braille character to disappear). Further, if the rotation-axial center of the cam 40A (40B) is far from the axial center (in the lengthwise direction) of the tactile pin 20A (20B) to some extent, a rotational moment is exerted on the cam 40A (40B) e.g. by the compression coil spring 10A (10B) which biases the tactile pin 20A (20B) against the cam 40A (40B).

In order to prevent the tactile pin 20A (20B) raised from the tactile surface 35 from being lowered back, the cam preferably has an outline shape to prevent the tactile pin 20A (20B) (at a bottom thereof) from allowing the cam 40A (40B) to generate a rotational torque, both in the ON-state (which can be referred to as an upper dead point) where the end of the tactile pin 20A (20B) is raised to a desired height from the tactile surface 35, and in the OFF-state (which can be referred to as a lower dead point) where the tactile pin 20A (20B) is lowered back to a level, which is the same as, or near, the tactile surface 35 (that is a level substantially corresponding to the tactile surface 35). Thus, an upper surface of the cam 40A (40B) has formed thereon a cam flange 41A (41B) having an outline shape (having flat side surfaces and a curved side surface described later) to raise the tactile pin 20A (20B), and to support the tactile pin 20A (20B) in the ON-state and the OFF-state. This allows the horizontal position of the rotation-axial center of the cam 40A (40B) to exist in the horizontal range of the bottom (circular surface) of the tactile pin 20A (20B) in both the ON-state and OFF-state where the tactile pin 20A (20B) contacts the cam 40A (40B), or more specifically the cam flange 41A (41B).

This structure makes it possible to maintain the state (ON-state) where the end of the tactile pin 20A (20B) is raised to a predetermined height from the tactile surface 35, or the state (OFF-state) where it is lowered back to near the tactile surface, even if the current to the shape memory wire 60A (60B) is disconnected. Furthermore, even if an excessive pressing force of a finger is applied to the tactile pin 20A (20B) in the ON-state, the tactile pin 20A (20B) is not lowered back. Note that at any position of the tactile pin 20A (20B), the tactile pin 20A (20B) is continuously biased by the compression coil spring 10A (10B) against the cam 40A (40B) so as to be prevented from unintentionally moving upward. The tactile pin 20A (20B) is preferably formed to be stepped to provide the compression coil spring 10A (10B) therearound.

As apparent from the above description, the cam 40A (40B) moves the tactile pin 20A (20B) forward and backward, while the shape memory wire 60A (60B) pivots the cam 40A (40B) forward. In other words, the cam 40A (40B) and the shape memory wire 60A (60B) function as an actuator to move the tactile pin 20A (20B) forward and backward. It is preferable to use a shape memory alloy such as nickel-titanium alloy, titanium alloy containing molybdenum and niobium, or the like as a shape memory material to form the shape memory wire 60A (60B). The present embodiment uses a function of the shape memory wire 60A (60B) which contracts when heated by current. If the shape memory material has a distortion factor of 2%, a wire having a length of about 25 mm is necessary to obtain a contraction amount of 0.5 mm. In the tactile pin display apparatus 100 of the present embodiment, the wire diameter of the shape memory wire 60A (60B) is designed to be about 58 μm.

It is necessary to properly treat the end of the shape memory wire 60A (60B) from the viewpoint of achieving long term reliability of the forward and backward movements of the tactile pin 20A (20B), reducing the size of the tactile pin display apparatus 100, facilitating its assembly work, and so on. Thus, in the tactile pin display apparatus 100, it is preferable to embed a solderable metal sleeve (using a metal such as copper, brass or solder-plated soft steel) in the base member 30T of the support housing 30, and to pinch and fix the end of the shape memory wire 60A (60B) by the metal sleeve. It is preferable to place metal sleeves, each pinching the shape memory wire 60A (60B), at predetermined intervals on the base member 30T as the external connection terminals 80A (80B) so as to stretch the shape memory wires 60A (60B), and to apply current (namely apply ON/OFF signals) from the external connection terminals 80A (80B) to move corresponding tactile pins 20A (20B) forward and backward. The support housing 30 comprising the tactile pin guide member 30P, cam support members 30C and base member 30T is preferably formed by molding a resin material. Preferable resin materials are polypropylene, polystyrene, ABS, polyamide, epoxy, acryl, vinyl chloride, vinylidene chloride, and so on.

One of the features of the tactile pin display apparatus 100 according to the present embodiment is that a reciprocal cam return plate 50 (cam return member) is used as means to pivot the cam 40A (40B) in a direction to move the tactile pin 20A (20B) backward (that is a direction to return to the OFF-state from the ON-state) (that is a pivot opposite to the pivot of the cam 40A (40B) based on the contraction of the shape memory wire 60A (60B)). It is preferable to use the driving force (cam return member driving source) of either a motor or an electromagnet (solenoid) to reciprocate the cam return plate 50. The reciprocal movement of the cam return plate 50 and the spring force of the compression coil spring 10A (10B) make it possible to pivot the cams 40A (40B) backward so as to return all the tactile pins 20A (20B) in the ON-state to the OFF-state (i.e. reset) instantaneously at a time.

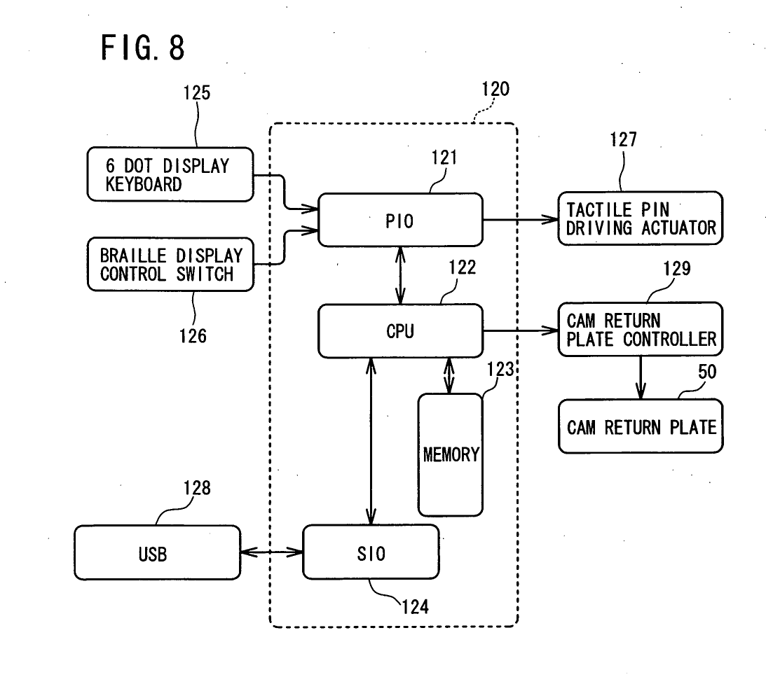

FIG. 8 is a schematic block diagram of a control circuit 120 as an example of a circuit to control e.g. the application of a current (application of ON/OFF signals) to the shape memory wire 60A (60B) as an actuator for moving the tactile pin 20A (20B) forward and backward. As shown in FIG. 8, the control circuit 120 comprises a parallel input/output unit (PIO) 121, a central processing unit (CPU) 122, a memory 123 and a serial input/output interface (SIO) 124. The PIO 121 is coupled to the CPU 122, and receives signals, for example, from a 6 dot display keyboard 125 and a braille display control switch 126, while the received signals are controlled by the CPU 122 and sent to a tactile pin driving actuator 127 (e.g. shape memory wire 60A (60B)). The SIO 124 is coupled to the CPU 122 and a universal serial bus (USB) 128. The CPU 122 is coupled to the memory 123. The CPU 122 provides an output signal thereof to a cam return plate controller 129 in response to signals received from the PIO 121, the SIO 124, the memory 123 and so on. The cam return plate controller 129 sends an output signal thereof to the cam return plate 50, and controls the reciprocal movement of the cam return plate 50.

Hereinafter, in order to describe the tactile pin display apparatus 100 according to the present embodiment in more detail, a tactile pin display unit 200 which is a unit element in the tactile pin display apparatus 100 will be described with reference to FIG. 3 to FIG. 7. Each of FIG. 3 and FIG. 4 is a schematic side view of a main part of the tactile pin display unit 200. FIG. 3 shows a state (OFF-state) in which the ends of the tactile pins 20A, 20B are at a level lowered back to near the tactile surface 35, while FIG. 4 shows a state (ON-state) in which the ends of the tactile pins 20A, 20B are at a level raised upward from the tactile surface 35. In FIG. 3 and FIG. 4, the tactile pin display unit 200 comprises tactile pins 20A, 20B to display characters and/or graphics.

The tactile pin display unit 200 further comprises: a tactile pin guide member 30P for supporting and allowing the tactile pins 20A, 20B to move forward and backward; cams 40A, 40B for raising ends of the tactile pins 20A, 20B to a desired height from the tactile surface 35 of the tactile pin guide member 30P; shape memory wires 60A, 60B to be heated by current for pivoting the cams 40A, 40B forward in a direction to raise the ends of the tactile pins 20A, 20B to a desired height from the tactile surface 35; and a cam return plate 50 (cam return member) for pivoting the cams 40A, 40B backward in a direction to move the ends of the tactile pins 20A, 20B backward to near the tactile surface 35 (level substantially corresponding to the tactile surface 35). One of the features of the present embodiment is that the cams 40A, 40B have an outline shape to prevent the tactile pins 20A, 20B from allowing the cams 40A, 40B to generate a rotational torque, both in the ON-state where the ends of the tactile pins 20A, 20B are raised to a desired height from the tactile surface 35, and in the OFF-state where the ends of the tactile pins 20A, 20B are lowered back to near the tactile surface 35.

More specifically, upper surfaces of the cams 40A, 40B have formed thereon cam flanges 41A, 41B having flat side surfaces 41Aa, 41Ac, 41Ba, 41Bc and curved side surfaces 41Ab, 41Bb which serve as an outline shape to raise the tactile pins 20A, 20B and to support the tactile pins 20A, 20B in the ON-state and OFF-state. This allows the horizontal positions of the rotation-axial centers of the cams 40A, 40B to exist in the horizontal ranges of the bottoms (circular surfaces) of the tactile pins 20A, 20B in both the ON-state and OFF-state where the tactile pins 20A, 20B contact the cams 40A, 40B, or more specifically the cam flanges 41A, 41B.

In other words, the rotation-axial centers of the cams 40A, 40B, when moved vertically in both the ON-state and OFF-state, can be allowed to pass through the bottoms (circular surfaces) of the tactile pins 20A, 20B. It is to be noted that in FIG. 3 and FIG. 4 described later, reference character y denotes an offset amount between the axial center in the lengthwise direction of the tactile pins 20A, 20B and the rotation-axial center of the cams 40A, 40B. According to the structure of the tactile pin display unit 200, and further the tactile pin display apparatus 100, of the present embodiment, this offset amount y is small, and the axial center in the lengthwise direction of the tactile pins 20A, 20B is not significantly far (neither required to be far) from the rotation-axial center of the cams 40A, 40B. Accordingly, the thickness of the tactile pin display unit 200, and further the tactile pin display apparatus 100, in the lateral direction in FIG. 3 and FIG. 4 can be kept small.

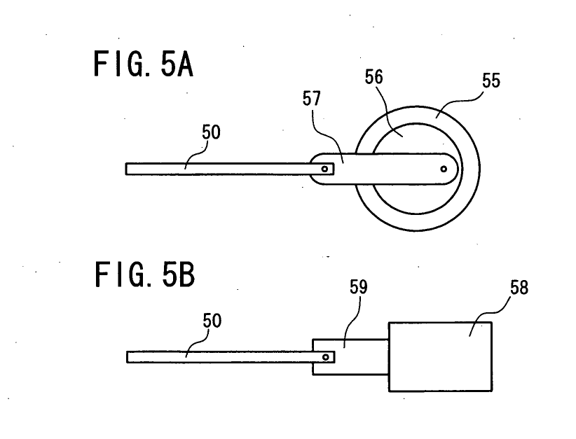

In FIG. 3, the pair of cams 40A, 40B are arranged in the same direction and pivoted in the same direction so as to move forward and backward the two tactile pins 20A, 20B which form one column in a braille number. Further, it is designed so that only when raising the tactile pins 20A, 20B to a desired height (bringing them to the ON-state) from the tactile surface 35, the shape memory wires 60A, 60B are supplied with current to contract. The tactile pins 20A, 20B are lowered back to near the tactile surface 35 (switched to the OFF-state) by a cam return plate (cam return means) which uses a motor or a solenoid (electromagnet) as a driving source (cam return member driving source) for the cam return plate 50. This will be described with reference to FIG. 5A and FIG. 5B.

FIG. 5A is a schematic side view showing a drive mechanism using a motor 55 for the cam return plate 50, while FIG. 5B is a schematic side view showing a drive mechanism using a solenoid 58 for the cam return plate 50. As shown in FIG. 5A, when the motor 55 is used, the motor 55 is provided with an eccentric disc 56 mounted thereon, while the eccentric disc 56 is connected to the cam return plate 50 with a link plate 57. The eccentric shaft 56 is rotated by rotation of the motor 55 so as to convert the rotation of the eccentric disc 56 into a reciprocal movement (horizontal movement) of the cam return plate 50. On the other hand, when the solenoid 58 is used as shown in FIG. 5B, a solenoid core 59 of the solenoid 58 is connected to the cam return plate 50 so as to allow the cam return plate 50 to be reciprocated (horizontally moved) by ON/OFF operation of the solenoid.

Note that although not shown, another method in the case of using a motor is as follows. The cam return plate is sandwiched and held at both ends thereof by a compression coil spring (different from the compression coil springs 10A, 10B) and a cam (different from the cams 40A, 40B). The cam return plate is pushed horizontally by the compression coil spring at an end of the cam return plate. On the other hand, the cam is mounted coaxially with the motor. When the motor rotates, the other end of the cam return plates slides on a side surface of the cam. The cam return plate is pressed toward the compression coil spring by the side surface of the cam, which rotates with the rotation of the motor. A curved projecting portion is formed on the side surface of the cam so as to allow the cam return plate to move toward the compression coil spring when the curved projecting portion contacts the cam return plate, and to allow the cam return plate to move away from the compression coil spring by the force of the compression coil spring when the curved projecting portion does not contact the cam return plate (when another curved portion of the cam contacts the cam return plate). The cam return plate is reciprocated (moved horizontally) by this mechanism.

FIG. 3 shows a state in which the shape memory wires 60A, 60B are not supplied with current, and do not contract. Accordingly, the cams 40A, 40B do not raise the tactile pins 20A, 20B. Thus, it is a state in which the ends of the tactile pins 20A, 20B are lowered back to near the tactile surface 35. In this case, it is possible to allow the horizontal positions of the rotation-axial centers of the cams 40A, 40B to exist in the horizontal ranges of the bottoms (circular surfaces) of the tactile pins 20A, 20B in the OFF-state where the bottoms of the tactile pins 20A, 20B contact the flat surfaces 41Aa, 41Ba of the cam flanges 41A, 41B. This makes it possible to stably maintain the tactile pins 20A, 20B in the OFF-state. Note that the projecting members 51A, 51B of the cam return plate 50 correspond to the cam lever members 45A, 45B of the cams 40, respectively. They are related in that the movement of the cam return plate 50 causes the projecting members 51A, 51B to engage with the cam lever members 45A, 45B, respectively. However, in the state shown in FIG. 3, the projecting members 51A, 51B do not engage with the cam lever members 45A, 45B.

Besides, the placement and thickness dimensions in the plate thickness direction of the cams 40A, 40B are taken into consideration so as to prevent the pair of left and right cams 40A, 40B from interfering with each other during pivoting. For example, in FIG. 3, when only the right cam 40A pivots counterclockwise while the left cam 40 is stopped, the right cam 40A is brought to contact with the left cam 40B, interfering with each other. In order to prevent this, the thickness of the cam flanges 41A, 41B of the left and right cams 40A, 40B is designed to be slightly smaller than half of the thickness of the cams 40A, 40B. In addition, the cam flanges 41A, 41B are formed at such positions on the cams 40A, 40B to be offset on the side surfaces of the cams 40A, 40B between the back and front sides of the paper of FIG. 3 so as to avoid mutual interference between these adjacent cams 40A, 40B. Note that preferable dimensions of elements relating to the thickness of these cam flanges 41A, 41B are that the diameter of each of the tactile pins 20A, 20B is about 2 mm, and the thickness of each of the cams 40A, 40B is about 1 mm, while the thickness of each of the cam flanges 41A, 41B is about 0.45 mm.

The shape memory wires 60A, 60B contract when heated by current. As a result, as shown in FIG. 4, the cams 40A, 40B pivot counterclockwise. Thus, the curved side surfaces 41Ab, 41Bb of the cam flanges 41A, 41B slide on the bottoms of the tactile pins 20A, 20B. The cam flanges 41A, 41B lift the tactile pins 20A, 20B so as to raise the ends of the tactile pins 20A, 20B to a desired height (e.g. about 0.5 mm) from the tactile surface 35, achieving the ON-state. In this case, as described above, it is possible to allow the horizontal positions of the rotation-axial centers of the cams 40A, 40B to exist in the horizontal ranges of the bottoms (circular surfaces) of the tactile pins 20A, 20B in the ON-state where the tactile pins 20A, 20B contact the flat surfaces 41Ac, 41Bc of the cam flanges 41A, 41B. This makes it possible to stably maintain the tactile pins 20A, 20B in the ON-state. More specifically, even if the current to the shape memory wires 60A, 60B is stopped, a rotational torque is not exerted on the cams 40A, 40B, so that the tactile pins 20A, 20B are not lowered back toward the tactile surface 35.

Next, in FIG. 4, in order to lower the tactile pins 20A, 20B to near the tactile surface 35, a drive mechanism (cam return member driving source), which uses a motor 55 and the like shown in FIG. 5A or a solenoid and the like shown in FIG. 5B, is used. When this drive mechanism is used to move the cam return plate 50 (cam return member) leftward in FIG. 4 (forward movement of the cam return plate 50), the projecting members 51 of the cam return plate 50, while engaging with the cam lever members 45A, 45B, push the cam lever members 45A, 45B. As a result, the cams 40A, 40B pivot clockwise in FIG. 4, so that the tactile pins 20A, 20B return to the OFF-state by the spring force of the compression coil springs 10A, 10B. Thereafter, when the cam return plate 50 is moved, i.e. restored (return of the cam return plate 50), by the above-described drive mechanism rightward in FIG. 4, then the tactile pin display unit 200 returns to the state of FIG. 3 from the state of FIG. 4. This clockwise pivoting of the cams 40A, 40B causes the contracted shape memory wires 60A, 60B to be mechanically and forcedly expanded. Subsequently, the cam return plate 50 is returned rightward in FIG. 4, whereby the tactile pin display unit 200 returns to the state of FIG. 3 (which can be referred to as reset state or standby state).

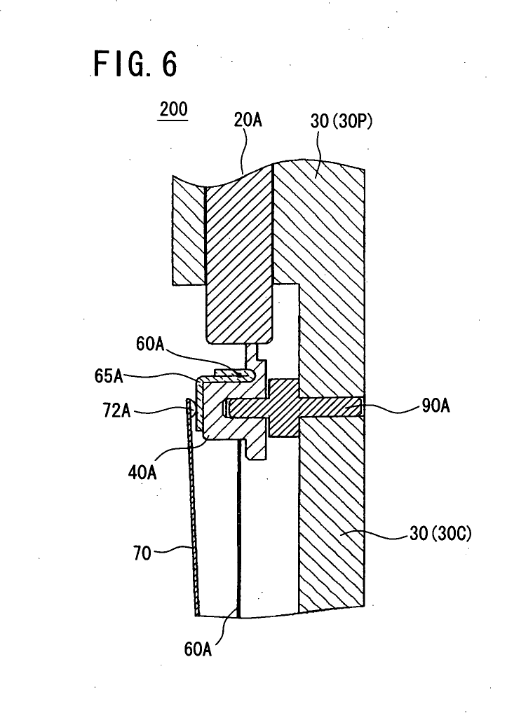

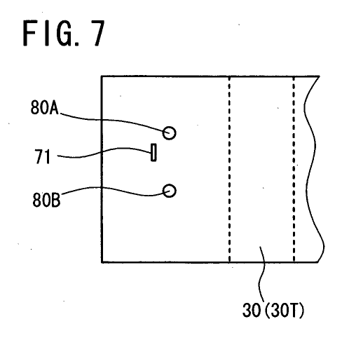

Referring next to FIG. 6 and FIG. 7, it will be described how a wire support fitting 65A supports a shape memory wire 60A (60B), and how a cam support member 30C of the support housing 30 supports a cam 40A (40B). FIG. 6 is a schematic cross-sectional view of a main part of the tactile pin display unit 200 of FIG. 3 cut along section line S-S, while FIG. 7 is a schematic bottom view of a main part of the tactile pin display unit 200 of FIG. 6. Although FIG. 6 and FIG. 7 show elements (e.g. tactile pin 20A) of one part of the tactile pin display unit with a suffix A added thereto, they are similar for the other elements (e.g. tactile pin 20B) with a suffix B added thereto. As shown in FIG. 6, a wire support fitting 65A (65B) (e.g. made of nickel-plate copper material) is formed to have one end thereof pinching a shape memory wire 60A (60B) (with a wire diameter of e.g. 58 μm) by caulking, and a main portion thereof formed integrally with the cam 40A (40B) to lie along an outer surface of the cam 40A (40B) so as to cover the rotation-axial center of the cam 40A (40B). A conducting brush 70 (e.g. made of phosphor bronze plate) is elastically contacted with the rotation-axial center of the wire support fitting 65A (65B). This makes it possible to minimize the frictional load between the pivoting wire support fitting 65A (65B) and the conducting brush 70, and to stabilize the contact resistance between the two.

As shown in FIG. 6, the conducting brush 70 is preferably provided with a substantially semi-spherical contact 72A (72B) made of silver at a portion thereof to elastically contact the wire support fitting 65A (65B). The cam 40A (40B) is pivotably supported by a shaft 90A (90B) provided to stand on the cam support member 30C which is a wall portion of the support housing 30. The conducting brushes 70 which elastically contact the two adjacent wire support fittings 65A, 65B, respectively, are preferably formed to be linked to each other at least one portion and provided with a common external connection terminal 71. This increases the rigidity of, and stabilizes the mounting position of, the conducting brushes 70. Further, it reduces the number of connections to external leads by one, thereby reducing the workload e.g. of soldering. As shown in FIG. 7, this external connection terminal 71 and metal sleeves 80A (80B) for electrically connecting the shape memory wires 60A (60B) and the conduction (sic, correctly conducting brushes 70) to the outside, respectively, are attached to the base member of the support housing 30.

As described in the foregoing, one of the features of the tactile pin display unit 200 and the tactile pin display apparatus 100 according to the present embodiment, which is formed by arranging multiple (eight) such tactile pin display units 200, is that the rotation-axial centers of the cams 40A, 40B are formed to exist in the bottoms (in the maximum diameters) of the tactile pins 20A, 20B in the ON-state and OFF-state of the tactile pins 20A, 20B. Thus, even if, for example in the ON-state, an excessive pressing force is applied to the tactile pins 20A, 20B e.g. by a finger of a user, and even if the current to the shape memory wires 60A, 60B is disconnected, it is possible to stably maintain the tactile pins 20A, 20B in the ON-state, and prevent them from being lowered back toward the OFF-state.

This eliminates the need for a holding current to maintain the tactile pins 20A, 20B in the ON-state, making it possible to achieve energy reduction. Further, the range of use of the shape memory wires 60A, 60B is limited to a minimum for the respective tactile pins 20A, 20B, so that it is possible to minimize the amount of use of the shape memory wires 60A, 60B and the power consumption to drive the shape memory wires 60A, 60B. In addition, all the tactile pins 20A, 20B can be instantaneously and automatically lowered back to near the tactile surface 35, namely can be instantaneously brought to the OFF-state, by a single reciprocal movement of the cam return plate 50 and by the spring force of the compression coil springs 10A, 10B to continuously bias the tactile pins 20A, 20B toward the cams 40A, 40B. These make it possible to achieve the simplification and reduction of the tactile pin display apparatus in size, weight and cost.

It is to be noted that the present invention is not limited to the above embodiments, and various modifications are possible within the spirit and scope of the present invention. For example, although the embodiments describe above show an example of a tactile pin display apparatus using tactile pins 20A, 20B of eight rows and two columns (sic, correctly: two rows and eight columns), it is possible to use tactile pins of arbitrary n rows and m columns. The present invention has been described above using presently preferred embodiments, but such description should not be interpreted as limiting the present invention. Various modifications will be easily conceivable and obvious to those ordinarily skilled in the art, who have read the description. Accordingly, the appended claims should be interpreted to cover all modifications and alterations which fall within the spirit and scope of the present invention.

### INDUSTRIAL APPLICABILITY

The tactile pin display apparatus according to the present invention can be used, for example, as a braille display terminal of an ATM (automatic teller machine), an automatic vending machine, an elevator and so on. Further, it can not only be used for braille display in a narrow sense, but also for two dimensional display or three dimensional display of braille graphics and so on.

1. A tactile pin display apparatus comprising:
tactile pins for displaying characters and/or graphics;
a support housing for supporting and allowing the tactile pins to move forward and backward;
cams for raising ends of the tactile pins to a desired height from a tactile surface;
springs for biasing the tactile pins against the cams;
shape memory wires to be heated by current for pivoting the cams forward in a direction to raise the ends of the tactile pins to the desired height from the tactile surface; and
cam return means including a cam return member to engage with the cams, and a cam return member driving source for reciprocating the cam return member so as to pivot the cams backward in a direction to move the ends of the tactile pins to a level substantially corresponding to the tactile surface when the cam return member driving source moves the cam return member forward.

2. The tactile pin display apparatus according to claim 1, wherein the shape memory wires are heated by current through conducting brushes.

3. The tactile pin display apparatus according to claim 2, which further comprises wire support fittings integrally provided on the cams for pinching the shape memory wires, wherein the conducting brushes are elastically contacted with the wire support fittings so as to heat the shape memory wires by current through the wire support fittings.

4. The tactile pin display apparatus according to claim 1, wherein the cam return member driving source comprises a motor, in which the cam return member is reciprocated by rotation of the motor.

5. The tactile pin display apparatus according to claim 1, wherein the cam return member driving source comprises a solenoid, in which the cam return member is reciprocated by ON/OFF operation of the solenoid.
